(19) United States
(12) Patent Application Publication
(10) Pub. No.: US 2017/0354951 A1
(43) Pub. Date: Dec. 14, 2017

(54) HYDROPHOBIC ADSORBENTS AND MERCURY REMOVAL PROCESSES THEREWITH

(71) Applicant: Chevron U.S.A. Inc., San Ramon, CA (US)

(72) Inventors: Dennis John O'Rear, Petaluma, CA (US); Joshua Allen Thompson, Martinez, CA (US)

(21) Appl. No.: 15/618,821

(22) Filed: Jun. 9, 2017

Related U.S. Application Data
(60) Provisional application No. 62/348,204, filed on Jun. 10, 2016.

(51) Int. Cl. B01J 20/28; B01J 20/18; B01J 20/02; C10L 3/10; B01J 20/22; B01J 20/32; B01J 20/20; B01D 53/02

(52) U.S. Cl. CPC B01J 20/28011; B01J 20/20; B01J 20/18; B01D 53/025; C10L 3/101; B01J 20/22; B01J 20/3287; B01J 20/0285; B01D 2256/245; B01D 2253/1128; B01D 2257/602; B01D 2253/102; C10L 2290/542; B01D 2253/108

(57) ABSTRACT

A hydrophobic adsorbent composition and process for removal of mercury from a gas phase fluid near the water and/or hydrocarbon dew point is disclosed herein.

### TECHNICAL FIELD

The invention relates generally to a composition useful for removing elemental mercury from a gas phase fluid, and further to methods using the composition useful for removing elemental mercury from a gas phase fluid.

### BACKGROUND

Heavy metals can be present in trace amounts in all types of produced fluids such as natural gases. The amount can range from below the analytical detection limit to several thousand ppbw (parts per billion by weight) depending on the source. In the case of natural gas, mercury is likely to be present as elemental mercury. Methods have been disclosed to remove heavy metals such as mercury from produced fluids including gas phase fluids. US Patent Publication No. 2011/0253375 discloses an apparatus and related methods for removing mercury from reservoir effluent by placing materials designed to adsorb mercury into the vicinity of a formation at a downhole location, and letting the reservoir effluent flow through the volume of the adsorbing material. US Patent Publication No. 2012/0073811 discloses a method for mercury removal by injecting a solid sorbent into a wellbore intersecting a subterranean reservoir containing hydrocarbon products. US Patent Publication No 2014/0066683 describes the control of elemental mercury by use of complexing agents and hydrate inhibitors injected at the well head. Other common approaches utilize treatments for the fluids once the fluids are recovered from subterranean reservoirs and brought to a surface production installation. U.S. Pat. No. 4,877,515 discloses a process for removing mercury from hydrocarbon streams, gas or liquid. U.S. Pat. No. 6,268,543 discloses a method for removing elemental mercury with a sulfur compound. U.S. Pat. No. 4,474,896 discloses using polysulfide based absorbents to remove elemental mercury (Hg0) from gaseous and liquid hydrocarbon streams.

Processing of natural gas to meet customer specifications or to purify it for conversion into liquefied natural gas (LNG) requires removal of several impurities: elemental mercury) (Hg⁰), water, hydrogen sulfide, carbon dioxide, and C₂+ hydrocarbons. Typically the heaviest of the C2+ hydrocarbons are separated in an inlet gas/liquid separator that received effluent from the well. Water is also removed at this point. This leaves a gas that is saturated with both water and hydrocarbons.

In the typical process scheme, this gas can first be treated with in an Acid Gas Removal Unit (ARGU) to remove CO2 and/or H2S if these impurities are present. This sweetened gas is then dehydrated to remove water by either absorption using a glycol like triethylene glycol (TEG), or dehydrated by an adsorbent like a zeolite. Finally the gas is treated in a Mercury Removal Unit (MRU) where a MRU adsorbent removes the mercury. The problem with this typical process scheme is that mercury-laden gas is also present in the ARGU and dehydrator. This results in mercury being present in the acid gas waste stream from the ARGU and the water-vent stream from the dehydrator. Mercury in these streams may need to be removed prior to their disposal. In addition, mercury accumulates in the solvents in both units making their reclamation and/or disposal challenging. Lastly mercury will adsorb on the surfaces of the equipment in these units. This makes inspection, repair and decommissioning of this processing equipment challenging.

For these reasons, the MRU adsorber is now often repositioned after the inlet separator. Doing this prevents mercury contamination in the ARGU and dehydrator. But it means that the MRU adsorber processes a gas often saturated with water and/or hydrocarbons. Since there is a pressure drop through the bed of the MRU, liquid water and/or hydrocarbon can form in the MRU. These materials can accumulate in the pores of the MRU adsorbent and reduce performance. This can result in reduced runtimes, frequent change outs and/or poor Hg removal.

In an attempt to minimize blockage of the pores with water and/or hydrocarbons, the gas fed to the MRU will often be preheated to a minimum of about 2° C., even, e.g., 28° C., above the temperature of the inlet separator. While this low heat increase might prevent condensation of liquid water and/or hydrocarbon in the bed of the MRU, these materials can still condense in the pores by capillary action and reduce performance. Heating the gas to higher temperatures might overcome this problem, but this is expensive and would eventually expose the MRU adsorbent to high temperatures and high moisture contents where it would lose mechanical strength.

What is needed is a MRU adsorbent capable of operating near the water and/or hydrocarbon dew point with a minimum loss in performance.

### SUMMARY

An embodiment of the invention is a hydrophobic adsorbent product and process for preparing comprising (a) an adsorbent material having pores therein and a pore volume, wherein the adsorbent material is selected from the group consisting of activated carbon, thiol-modified self-assembled monolayers on mesoporous supports, zeolites, and supported metal sulfides; and (b) a fluid immiscible with water at least partially filling the pores of the adsorbent material to form the hydrophobic adsorbent; wherein the hydrophobic adsorbent has at least a 50% lower uptake of water than the adsorbent material without the fluid at least partially filling the pores when exposed to saturated water vapor at room temperature.

An additional embodiment is a process for removing elemental mercury from a gas phase fluid comprising contacting the gas phase fluid having an first elemental mercury content and having a water dew point with the hydrophobic adsorbent of supra in a vessel at a temperature less than or equal to 28° C. from the water dew point thereby forming a gas phase fluid having a second elemental mercury content.

### Definitions

The following terms will be used throughout the specification and will have the following meanings unless otherwise indicated.

“Mercury Removal Unit (MRU) Adsorbent” is an adsorbent capable of adsorbing elemental mercury from the gas phase. Examples of MRU Adsorbents include activated carbon (either as such or treated with sulfur compounds or halogens), thiol-modified SAMMs, zeolites (either as such or with silver), and supported metal sulfides (such as copper sulfide on alumina).

“Hydrophobic MRU Adsorbent” is a treated MRU adsorbent that shows less uptake of water compared to the original MRU adsorbent. When exposed to saturated water vapor at room temperature, the uptake of water is reduced by 50% or more in one embodiment. In another embodiment, the uptake is reduced by 75% or more. In another embodiment, the update is reduced by 90% or more. Examples of hydrophobic MRU adsorbents include MRU adsorbents in which the pores have been at least partially filled with a fluid that is immiscible with water. Examples also include MRU adsorbents that have been treated with a hydrophobicity inducing agent.

“At least partially filled” refers to the inclusion of a fluid immiscible with water in the pores of a MRU adsorbent. Compared to the total pore volume of the adsorbent, the amount of fluid immiscible with water is 10% or more of the total pore volume in one embodiment. In a second embodiment, the amount of fluid immiscible with water is 25% or more of the total pore volume. In a third embodiment, the amount of fluid immiscible with water is 50% or more of the total pore volume. In a four embodiment, the amount of fluid immiscible with water is 90% or more of the total pore volume. In a fifth embodiment, the amount of fluid immiscible with water is essentially 100% of the total pore volume.

“Fluids Immiscible with Water” refer to liquids that dissolve in water less than or equal to 25%. In other words, if equal volumes of a fluid and water are mixed, at least 75% of the fluid will remain as a separate phase from the water. Likewise, 25% or less will be dissolved in the water and be present in the aqueous phase. In another embodiment, the liquids dissolve in water less than or equal to 10%. In another embodiment, the liquids dissolve in water less than or equal to 1%. The fluids immiscible with water should have solubility's for mercury greater than the typical solubility of mercury in water 2 ppb at room temperature in one embodiment. In a second embodiment, the fluids immiscible with water have a solubility of mercury of 50 ppb or more. In a third embodiment, the fluids immiscible with water have a solubility of mercury of 100 ppb or more. In a fourth embodiment, the fluids immiscible with water have a solubility of mercury of 1000 ppb or more. Examples of fluids immiscible with water include hydrocarbons (such as individual hydrocarbons, jet fuel, diesel fuel, condensate, alcohols, halocarbons (liquids containing carbon, a halogen such as F, Cl, Br, or I, and optionally hydrogen and oxygen), crude oil, lubricating base stock, formulated lubricants, and white oil.

“Hydrophobicity Inducing Agent” is a chemical which changes the surface properties of the MRU adsorbent while reducing the total pore volume by 50% or less in one embodiment. In a second embodiment, the total pore volume is reduced by 25% or less. In a third embodiment, the total pore volume is reduced by 10% or less.

“Hydrocarbon Dew Point” refers to the temperature (at a given pressure) at which the hydrocarbon components of any hydrocarbon-rich gas mixture, such as natural gas, will start to condense out of the gaseous phase. It is often also referred to as the HDP or the HCDP. The hydrocarbon dew point is a function of the gas composition as well as the pressure. The hydrocarbon dew point can be calculated based on the gas composition or measured. While numerous techniques are available to measure or calculate the hydrocarbon dew point, if these methods are in discrepancy, the Bureau of Mines Manual Dew Point Tester should be used.

“Water Dew Point” refers to the temperature at which water or in a sample of gas at constant pressure condenses into liquid water at the same rate at which it evaporates. At temperatures below the dew point, water will leave the air-gas. The condensed water is called dew when it forms on a solid surface. The condensed water is called either fog, mist or a cloud when it is present in the gas. The water dew point can be measured by use of ASTM D1142.

“Thiol-modified SAMMS” are “Self-Assembled Monolayers on Mesoporous Supports”. These refer to a material developed by the Pacific Northwest National Laboratory and trademarked as SAMMS™, which can be modified by use of thiols. An example of the preparation and use of thiol-modified SAMMS™ for the removal of cationic mercury dissolved in water is described in Prepr. Pap.-Am. Chem. Soc., Div. Fuel Chem. 2004, 49 (1), 288, incorporated herein by reference in its entirety.

“Trace amount” refers to the amount of mercury in the natural gas. The amount varies depending on the natural gas source, ranging from 0.01 μg/Nm3 to up to 30,000 μg/Nm3.

“Heavy metals” refers to gold, silver, mercury, osmium, ruthenium, uranium, cadmium, tin, lead, selenium, and arsenic. While the description described herein refers to mercury removal, in one embodiment, the treatment removes one or more of the heavy metals.

“Volatile mercury” refers to mercury that is present in the gas phase of well gas or natural gas. In one embodiment, volatile mercury comprises primarily elemental mercury (Hg⁰) with some dialkylmercury compounds (dimethyl mercury).

“Mercury sulfide” may be used interchangeably with HgS, referring to mercurous sulfide, mercuric sulfide, and mixtures thereof. Normally, mercury sulfide is present as mercuric sulfide with an approximate stoichiometric equivalent of one mole of sulfide ion per mole of mercury ion. Mercury sulfide is not appreciably volatile, and not an example of volatile mercury. Crystalline phases include cinnabar, metacinnabar and hypercinnabar with metacinnabar being the most common.

“Production facility” means any facility for receiving natural gas and preparing the gas for sale. The production facility may be a ship-shaped vessel located over a subsea well site, an FPSO vessel (floating production, storage and offloading vessel) located over or near a subsea well site, a near-shore separation facility, or an onshore separation facility. Synonymous terms include “host production facility” or “gathering facility.”

“Produced fluids” refers the mixture of hydrocarbons, e.g., natural gas, some crude oil, hydrocarbon condensate, and produced water that is removed from a geologic formation via a production well.

“Gas Phase Fluid” refers to a mixture of hydrocarbons and impurities, which is separated from produced fluids at a production well. The gas phase fluid will have a water dew point and volatile mercury concentration.

### DETAILED DESCRIPTION

Generally, natural gas streams comprise low molecular weight hydrocarbons such as methane, ethane, propane, other paraffinic hydrocarbons that are typically gases at room temperature, etc. Mercury is present in natural gas as volatile mercury, including elemental mercury Hg⁰, in levels ranging from about 0.01 μg/Nm3 to 30,000 μg/Nm3. The mercury content may be measured by various conventional analytical techniques known in the art, including but not limited to cold vapor atomic absorption spectroscopy (CV-AAS), inductively coupled plasma atomic emission spectroscopy (ICP-AES), X-ray fluorescence, or neutron activation. If the methods differ, ASTM D 6350 is used to measure the mercury content.

Depending on the source or sources of the natural gas, in addition to mercury, the stream can have varying amount of (produced) water ranging from 0.1 to 90 vol. % water in one embodiment, from 5 to 70 vol. % water in a second embodiment, and from 10-50 vol. % water in a third embodiment. The volume percents are calculated at the temperature and pressure of the pipeline.

Natural gas is often found in wells located in remote locations and must be transported from the wells to developed locations for use. This can be done by a production line, or by conversion of the methane in the natural gas into a liquefied natural gas (LNG) for transport.

The commercial mercury adsorbents have problems when condensable hydrocarbons or water is present in the gas. These condensed liquids either block the adsorption of the elemental mercury or cause the adsorbent to lose mechanical strength. The weakened adsorbent can crumble and lead to plugging in the adsorber. In crude and gas production, the mercury-containing gas is often obtained from separators or from compressor-chillers. In both cases the gas can be at or near its water and/or hydrocarbon dew point. To minimize problems from loss of the adsorbent, the gas is often heated to temperatures above its dew point. Alternatively, the gas can be chilled and the water and/or hydrocarbons condensed. The gas is then reheated prior to the mercury adsorption step. In both processes, expensive equipment is required. Also, the condensed water and hydrocarbon liquids from the second alternative can contain mercury and require additional treatment. It is recommended that hydrocarbon gases be heated to 28° C. above their hydrocarbon dew point to assure that no liquids condense.

Described hereinafter are hydrophobic MRU adsorbents which show reduced water uptake and improved ability to remove mercury when the temperature of the adsorber is less than or equal to 28° C. from the water dew point. The hydrophobic MRU Adsorbent is used under conditions where water would normally adsorb in the pores and cause a loss in performance. The temperature of the adsorber is less than or equal to 28° C. from the water dew point in one embodiment; less than or equal to 10° C. from the water dew point in another embodiment; less than or equal to 5° C. from the water dew point in another embodiment; less than or equal to 2° C. from the water dew point in another embodiment; and equal to or less than the water dew point in a fifth embodiment. In a sixth embodiment, water condenses as a liquid phase in the adsorber.

In one embodiment, the mercury content of the gas is reduced by 50% or more. In another embodiment, it is reduced by 90% or more. In another embodiment, it is reduced by 95% or more. In another embodiment, it is reduced by 99% or more. In one embodiment, the mercury content of the gas is reduced to at or below 10 μg/m3. In another embodiment, the mercury content of the gas is reduced to at or below 1 μg/m3. In another embodiment, the mercury content of the gas is reduced to at or below 0.1 μg/m3. In another embodiment, the mercury content of the gas is reduced to at or below 0.01 μg/m3.

In one embodiment, a fluid immiscible with water is added to at least partially fill the pores of a porous adsorbent material. Water has a low solubility for elemental mercury around 2 ppb at room temperature. By contrast, hydrocarbons and other fluids have much higher solubilities for elemental mercury, e.g., on the order of 1000 times the solubility of water for elemental mercury. Thus, partially filling the pores with a fluid immiscible with water permits the elemental mercury in the gas phase to enter the pores of the hydrophobic MRU adsorbent and react with the adsorption sites, e.g., copper sulfide on an adsorbent. It has been known in the state of the art that average pore diameters, Dp, may be calculated from measured pore volumes and surface areas assuming uniform cylindrical pores (Emmett. et al. J. Am. Chem. Soc., 65, 1253 (1943); Hirschler et al, Industr. and Eng. Chem., vol. 47(2), 1955. In one embodiment, the MRU adsorbent is exposed to the fluid immiscible with water prior to loading the adsorbent in the MRU vessel. In another embodiment, the MRU adsorbent is exposed to the fluid immiscible with water after it has been loaded in the MRU vessel.

In one embodiment, the adsorbent material can be one or more of activated carbon, thiol-modified self-assembled monolayers on mesoporous supports, zeolites, and supported metal sulfides. “Self-assembled monolayers on mesoporous supports” refers to a material developed by the Pacific Northwest National Laboratory and trademarked as SAMMS™, which can be modified by use of thiols. An example of the preparation and use of thiol-modified SAMMS™ for the removal of cationic mercury dissolved in water is described in Prepr. Pap.-Am. Chem. Soc., Div. Fuel Chem. 2004, 49 (1), 288, incorporated herein by reference in its entirety.

Additives to the adsorbent may be utilized to combat problems previously associated with adsorbents. In one embodiment in addition to the adsorbents, at least one of an anti-foam and/or a demulsifier is added. As used herein, the term anti-foam includes both anti-foam and defoamer materials, for preventing foam from happening and/or reducing the extent of foaming. Additionally, some anti-foam material may have binary functions, including but not limited to reducing/mitigating foaming under certain conditions, and preventing foam from happening under other operating conditions. Anti-foam agents can be selected from a wide range of commercially available products such as silicones, e.g., polydimethyl siloxane (PDMS), polydiphenyl siloxane, fluorinated siloxane, etc., in an amount of 1 to 500 ppm.

In one embodiment, at least a demulsifier is added in a concentration from 1 to 5,000 ppm. In another embodiment, a demulsifier is added at a concentration from 10 to 500 ppm. In one embodiment, the demulsifier is a commercially available demulsifier selected from polyamines, polyamidoamines, polyimines, condensates of o-toluidine and formaldehyde, quaternary ammonium compounds and ionic surfactants. In another embodiment, the demulsifier is selected from the group of polyoxyethylene alkyl phenols, their sulphonates and sodium sulphonates thereof. In another embodiment, the demulsifier is a polynuclear, aromatic sulfonic acid additive.

In one embodiment, an MRU adsorbent is treated with a hydrophobicity inducing agent that alters the surface properties of the adsorbent such that it no longer adsorbs water. Examples of hydrophobicity inducing agents which functionally achieve this include but are not limited to silanes, including halogenated silanes such as chlorosilanes and fluorosilanes, Exemplary hydrophobic inducing agents and methods for making are seen in US20020114958A1, US20050123739 A1, U.S. Pat. No. 5,354,881 A, U.S. Pat. No. 7,341,706 B2 and U.S. Pat. No. 4,888,309 herein incorporated by reference.

### EXAMPLES

### Example 1—Comparative Example of Current Operation

Samples of commercial adsorbents were unloaded from a MRU and analyzed. The MRU had been processing gas from the inlet separator and suffering from short run lives and excessive amounts of mercury slip in the unit. Mercury slip is a high level of mercury in the treated gas. This unit was operating at the dew point of both water and hydrocarbons. Both materials condensed in the bed and liquid water and liquid hydrocarbon were withdrawn at the exit of the MRU.

Samples from two units (A and B) were obtained from six different depths in the units. Samples 1 were from near the inlet and samples 6 were near the outlet. Samples 2, 3, 4 and 5 were spaced evenly throughout the bed. The samples were analyzed by TGA-MS. The weight loss at 150 and 280° C. were recorded. The MS indicated only water (mass 18) in the vapor product, thus the pores were filled essentially with only water, not hydrocarbons. The loss at 150° C. is attributed to bulk water while the additional loss at 280° C. is attributed to water adsorbed more tightly on the surface of the support. Results are summarized in Table 1.

TABLE 1

| | | Weight | Weight | |
|---|---|---|---|---|
| | | Loss % at | loss % at | Wt % |
| Unit | Sample | 150 C. | 280 C. | Mercury |
| A | 1 | 14.95 | 18.47 | 1.13 |
| A | 2 | 13.83 | 17.38 | 0.87 |
| A | 3 | 16.38 | 19.70 | 0.61 |
| A | 4 | 15.15 | 18.97 | 0.49 |
| A | 5 | 13.65 | 17.75 | 0.30 |
| A | 6 | 9.45 | 13.09 | 0.18 |
| B | 1 | 14.78 | 18.53 | 1.16 |
| B | 2 | 14.58 | 18.27 | 1.00 |
| B | 3 | 15.40 | 18.84 | 0.71 |
| B | 4 | 15.68 | 19.01 | 0.47 |
| B | 5 | 14.59 | 18.01 | 0.27 |
| B | 6 | 11.26 | 14.78 | 0.12 |

The mercury levels are significantly below what had been observed historically when the MRU was located after the dehydrator ˜10-20%. JMC reference “Minimizing mercury emissions from Gas Processing and LNG plants” says 10-15%.

### Example 2

In this example, gas phase elemental mercury was dissolved in a white oil which is an example of a fluid immiscible with water. First, five grams of elemental mercury was placed in an impinger at 100° C. and 0.625 SCF/min of nitrogen gas was passed over through the impinger to form an Hg-saturated nitrogen gas stream. This gas stream was then bubbled through 3123 pounds of Superla® white oil held at 60-70° C. in an agitated vessel. The operation continued for 55 hours until the mercury level in the white oil reached 500 ppbw by a Lumex™ analyzer. This illustrates the high solubility of mercury in a fluid immiscible with water. The high solubility will enhance diffusion from the gas phase through the pores of the adsorbent.

What is claimed is:

1. A hydrophobic adsorbent composition for removal of elemental mercury from a gas phase fluid, the comprising:
a. an adsorbent material having pores therein and a pore volume, wherein the adsorbent material is selected from the group consisting of activated carbon, thiol-modified self-assembled monolayers on mesoporous supports, zeolites, and supported metal sulfides; and
b. a fluid immiscible with water at least partially filling the pores of the adsorbent material to form the hydrophobic adsorbent;
wherein the hydrophobic adsorbent has at least a 50% lower uptake of water than the adsorbent material without the fluid at least partially filling the pores when exposed to saturated water vapor at room temperature.

2. The hydrophobic adsorbent of claim 1 wherein the hydrophobic adsorbent has at least a 75% lower uptake of water than the adsorbent material without the fluid at least partially filling the pores when exposed to saturated water vapor at room temperature.

3. The hydrophobic adsorbent of claim 1 wherein the hydrophobic adsorbent has at least a 90% lower uptake of water than the adsorbent material without the fluid at least partially filling the pores when exposed to saturated water vapor at room temperature.

4. The hydrophobic adsorbent of claim 1 wherein the fluid immiscible with water has a solubility for mercury greater than 2 ppb at room temperature.

5. The hydrophobic adsorbent of claim 1 wherein the fluid immiscible with water has a solubility for mercury greater than 50 ppb at room temperature.

6. The hydrophobic adsorbent of claim 1 wherein the fluid immiscible with water has a solubility for mercury greater than 100 ppb at room temperature.

7. The hydrophobic adsorbent of claim 1 wherein the fluid immiscible with water has a solubility for mercury greater than 1000 ppb at room temperature.

8. The hydrophobic adsorbent of claim 1 wherein the fluid immiscible with water is selected from the group consisting of hydrocarbons, jet fuel, diesel fuel, condensate, alcohols, halocarbons, crude oil, lubricating base stock, formulated lubricants, and white oil.

9. The hydrophobic adsorbent of claim 1 wherein the fluid immiscible with water occupies 10% or more of the pore volume of the adsorbent material.

10. The hydrophobic adsorbent of claim 1 wherein the fluid immiscible with water occupies 25% or more of the pore volume of the adsorbent material.

11. The hydrophobic adsorbent of claim 1 wherein the fluid immiscible with water occupies 50% or more of the pore volume of the adsorbent material.

12. The hydrophobic adsorbent of claim 1 wherein the fluid immiscible with water occupies 90% or more of the pore volume of the adsorbent material.

13. The hydrophobic adsorbent of claim 1 wherein the fluid immiscible with water occupies 100% or more of the pore volume of the adsorbent material.

14. A hydrophobic adsorbent composition for removal of elemental mercury from a gas phase fluid, the adsorbent comprising:
a. an adsorbent material having pores therein, a pore volume and a surface, wherein the adsorbent material is selected from the group consisting of activated carbon, thiol-modified self-assembled monolayers on mesoporous supports, zeolites, and supported metal sulfides; and
b. a surface modifier comprising a hydrophobic agent on the surface of the adsorbent material to form the hydrophobic adsorbent;
wherein the hydrophobic adsorbent has a pore volume at least 50% lower than the adsorbent material without the surface modifier and wherein the hydrophobic adsorbent has at least a 50% lower uptake of water than the adsorbent material without the surface modifier when exposed to saturated water vapor at room temperature.

15. The hydrophobic adsorbent of claim 14 wherein the hydrophobic adsorbent has a pore volume at least 25% lower than the adsorbent material without the surface modifier.

16. The hydrophobic adsorbent of claim 14 wherein the hydrophobic adsorbent has a pore volume at least 10% lower than the adsorbent material without the surface modifier.

17. The hydrophobic adsorbent of claim 14 wherein the hydrophobic agent is selected from the group consisting of chlorosilanes, fluorosilanes and combinations thereof.

18. A process to remove elemental mercury from a gas phase fluid, the process comprising:
a. contacting the gas phase fluid having an first elemental mercury content and having a water dew point with the adsorbent of claim 1 or claim 2 in a vessel at a temperature less than or equal to 28° C. from the water dew point thereby forming a gas phase fluid having a second elemental mercury content.

19. The process according to claim 2 wherein the temperature is less than or equal to 10° C. from the water dew point.

20. The process according to claim 2 wherein the temperature is less than or equal to 5° C. from the water dew point.

21. The process according to claim 2 wherein the temperature is less than or equal to 1° C. from the water dew point.

22. The process according to claim 2 wherein the temperature is less than or equal to the water dew point.

23. The process according to claim 2 wherein liquid water condenses in the vessel.

24. The process according to claim 2 wherein liquid hydrocarbons condense in the vessel.

25. The process according to claim 2 wherein the second elemental mercury content is at least 50% lower than the first elemental mercury content of the gas phase fluid.

26. The process according to claim 2 wherein the second elemental mercury content is at least 90% lower than the first elemental mercury content of the gas phase fluid.

27. A process for preparing a hydrophobic adsorbent useful in a process to remove elemental mercury from a gas phase fluid, the process comprising:
a. providing an adsorbent material having pores therein selected from the group consisting of activated carbon, thiol-modified self-assembled monolayers on mesoporous supports, zeolites, and supported metal sulfides; and
b. at least partially filling the pores of the adsorbent material with a fluid immiscible with water to form the hydrophobic adsorbent; such that the hydrophobic adsorbent has at least a 50% lower uptake of water than the adsorbent material without the fluid at least partially filling the pores when exposed to saturated water vapor at room temperature.

28. The process of claim 27 wherein the process occurs within a vessel.

29. A process for preparing a hydrophobic adsorbent useful in a process to remove elemental mercury from a gas phase fluid, the process comprising:
a. providing an adsorbent material having pores therein, a pore volume and a surface, wherein the adsorbent material is selected from the group consisting of activated carbon, thiol-modified self-assembled monolayers on mesoporous supports, zeolites, and supported metal sulfides; and
modifying the surface of the adsorbent material with a hydrophobic agent to form the hydrophobic adsorbent; such that the hydrophobic adsorbent has a pore volume at least 50% lower than the adsorbent material without the surface modifier and the hydrophobic adsorbent has at least a 50% lower uptake of water than the adsorbent material without the hydrophobic agent when exposed to saturated water vapor at room temperature.
